(19) United States
(12) Patent Application Publication
(10) Pub. No.: US 2026/0254929 A1
(43) Pub. Date: Aug. 27, 2026

(54) METHOD FOR SUPPORTING CLUSTERING OF PROJECTION DEVICES AND SYSTEM THEREFOR

(71) Applicant: CJ 4DPLEX CO., LTD., Seoul (KR)

(72) Inventors: Kyoung Hwan KIM, Seoul (KR); Kwon Il KIM, Seoul (KR); Seong Pil HYUN, Seoul (KR); Dae Hyun WI, Seoul (KR); Bum Ki KIM, Seoul (KR); Seung Hwa JEONG, Seoul (KR)

(21) Appl. No.: 19/650,262

(22) Filed: Apr. 16, 2026

Related U.S. Application Data
(63) Continuation of application No. PCT/KR2024/015860, filed on Oct. 18, 2024.

(30) Foreign Application Priority Data
Oct. 18, 2023 (KR) 10-2023-0139840

(51) Int. Cl. H04N 9/31

(52) U.S. Cl. CPC H04N 9/3147; H04N 9/3185

(57) ABSTRACT

The present invention relates to a method and system for supporting the clustering of projection devices. Specifically, the present invention relates to a method and system that allows an administrator (user), who wishes to cluster multiple projection devices within a theater, to utilize interfaces provided by a management server, thereby assisting in clustering the multiple projection devices.

### CROSS REFERENCE TO RELATED APPLICATION(S)

This application is a continuation application under 35 U.S.C. 120, claiming a priority and benefit of International Application No. PCT/KR2024/015860 filed on Oct. 18, 2024, claiming priority based on Korean Patent Application No. 10-2023-0139840 filed on Oct. 18, 2023, the disclosure of which are incorporated herein by reference in their entirety.

### TECHNICAL FIELD

The present invention relates to a method and system for supporting the clustering of projection devices. Specifically, the present invention relates to a method and system that allows an administrator (user), who wishes to cluster multiple projection devices within a theater, to utilize interfaces provided by a management server, thereby assisting in clustering the multiple projection devices.

### BACKGROUND ART

Multi-screen theaters, which aim to enhance immersion by utilizing multiple projection devices and multiple projection surfaces, are gaining popularity. In such, it is crucial to define the multiple projection devices as a single cluster for unified control, as the same video must be projected onto multiple surfaces. Moreover, it is crucial to adjust the video to ensure proper projection by the collectively controlled projection devices.

However, these tasks of clustering and video adjustment are too complex and difficult for the administrator, i.e., the user, to perform manually by handling the machines. Without software to support these tasks, it would be nearly impossible to accomplish them.

The present invention has been proposed in light of these issues, with the aim of performing clustering for unified control of multiple projection devices within a theater, and further supporting the adjustment of the videos projected by these projection devices.

### DISCLOSURE

### Technical Problem

Therefore, an object of the present invention is to assist a user in easily clustering multiple projection devices.

In particular, another object of the present invention is to enhance user convenience by providing dedicated interfaces that enable intuitive understanding and execution of tasks, even for users with limited experience.

Still another object of the present invention is to enhance user convenience by providing interfaces that not only facilitate the clustering of projection devices but also allow for the adjustment of videos to ensure they are properly projected onto projection surfaces following the clustering process.

Meanwhile, the above-mentioned objects of the present invention are not limited to those mentioned above, and other objects not mentioned will be clearly understood by those skilled in the art from the following description.

### Technical Solution

To solve the aforementioned issues, an embodiment of the present invention provides a method for supporting the clustering of projection devices, comprising: (a) a theater information setup step of providing a theater information input interface that allows a user to set up theater information and receiving a theater information input for a theater that includes multiple projection surfaces from the user; (b) a projection device addition step of providing a projection device setup interface for setting up multiple projection devices to output images across the multiple projection surfaces and receiving a projection device addition input for the multiple projection devices from the user; and (c) a clustering step of providing a clustering interface for clustering the added multiple projection devices and receiving a clustering adjustment input from the user.

Moreover, the method for supporting the clustering of projection devices may further include: (d) an image area setting step of providing an image area setting interface for setting up an image area of the images projected by the clustered projection devices and receiving an image area adjustment input from the user.

Furthermore, according to the method for supporting the clustering of projection devices, the clustering interface may include: multiple projection screen areas each corresponding to each of the projection devices to be clustered; multiple clustering points displayed on each of the projection screen areas; and an editing menu for supporting the user's clustering adjustment input.

In addition, according to the method for supporting the clustering of projection devices, clustering projection points each corresponding to each of the multiple clustering points are displayed on a projection area where the images output by the multiple projection devices are projected, and the clustering adjustment input from the user may include an input that the user wishes to overlap at least some of the clustering projection points.

Additionally, according to the method for supporting the clustering of projection devices, the clustering interface may further display a polygon formed by connecting the multiple clustering points, and a polygon formed by connecting the clustering projection points on the projection area.

Moreover, according to the method for supporting the clustering of projection devices, the method may further include, after step (d), a fine-tuning step of providing an image warping interface for editing the warping of the images projected by the clustered projection devices and receiving an image warping adjustment input for fine-tuning the images from the user.

Furthermore, according to the method for supporting the clustering of projection devices, the image warping interface may include a mesh editing screen for displaying multiple reference lines and multiple patterns; multiple control points displayed on the mesh editing screen; and an editing menu for supporting the user's image warping adjustment input.

In addition, according to the method for supporting the clustering of projection devices, the method may further include, after step (d), an edge blending step of providing an edge blending interface for edge blending of the images projected by the clustered projection devices and receiving an image area to be edge-blended and an edge blending start input from the user.

Additionally, according to the method for supporting the clustering of projection devices, the method may further include, after step (d), a masking step of providing a masking interface for masking at least some areas of the images projected by the clustered projection devices and receiving a masking area editing input from the user.

Moreover, according to the method for supporting the clustering of projection devices, the masking interface may include editing menus for supporting the user's masking area editing input, wherein the editing menus may include a masking area display button; and a button for linear editing or curved editing of the masking area.

Another embodiment of the present invention provides a management server for supporting the clustering of projection devices, the management server including a central processing unit and a memory, wherein the central processing unit may execute instructions stored in the memory for performing a method for supporting the clustering of projection devices, wherein the method for supporting the clustering of projection devices may include: (a) a theater information setup step of providing a theater information input interface that allows a user to set up theater information and receiving a theater information input for a theater that includes multiple projection surfaces from the user; (b) a projection device addition step of providing a projection device setup interface for setting up multiple projection devices to output images across the multiple projection surfaces and receiving a projection device addition input for the multiple projection devices from the user; and (c) a clustering step of providing a clustering interface for clustering the added multiple projection devices and receiving a clustering adjustment input from the user.

Moreover, the method for supporting the clustering of projection devices may further include: (d) an image area setting step of providing an image area setting interface for setting up an image area of the images projected by the clustered projection devices and receiving an image area adjustment input from the user.

### Advantageous Effects

According to the present invention, there is an advantage of easily clustering multiple projection devices.

Moreover, According to the Present Invention, the User Can Adjust various parameters while viewing images projected onto the actual projection surface, allowing for clustering and video adjustment in the same environment as the actual video projection.

Furthermore, according to the present invention, even the user with limited experience can easily perform the tasks through intuitive interfaces.

Meanwhile, the above-mentioned effects of the present invention are not limited to those mentioned above, and other technical effects not mentioned will be clearly understood by those skilled in the art from the following description.

### DESCRIPTION OF DRAWINGS

FIG. 1 is a schematic diagram illustrating the entire system required to implement a method and system for supporting the clustering of projection devices according to the present invention.

FIG. 2 is a flowchart illustrating a method for supporting the clustering of projection devices according to the present invention in sequence.

FIG. 3 illustrates an example of an interface provided to a user for inputting theater information, i.e., a theater information input interface.

FIG. 4a illustrates a theater projection surface on which image areas output by multiple projection devices are displayed during the step of adding projection devices, and FIG. 4b shows photographs with identifiers displayed on any projection surface in an actual theater to identify the projection devices added. A specific

FIG. 5 illustrates an example of a clustering interface.

FIG. 6 illustrates how the interface is displayed on the actual projection surface.

FIG. 7 illustrates how the reference area is displayed on the actual projection surface.

FIG. 8 illustrates an example of an image area setting interface.

FIG. 9 illustrates the types of adjustments that can be performed during the adjustment step after the image area setting.

FIG. 10 illustrates an example of an image warping interface.

FIG. 11 illustrates the projections displayed before and after edge blending.

FIG. 12 illustrates the masking functions presented through a masking interface.

### MODE FOR INVENTION

Details regarding the objects and technical features of the present invention and the resulting effects will be more clearly understood from the following detailed description based on the drawings attached to the specification of the present invention. Preferred embodiments according to the present invention will be described in detail with reference to the attached drawings.

The embodiments disclosed in this specification should not be construed or used as limiting the scope of the present invention. It is obvious to those skilled in the art that the description, including the embodiments, of this specification has various applications. Therefore, any embodiments described in the detailed description of the present invention are illustrative to better illustrate the present invention and are not intended to limit the scope of the present invention to the embodiments.

The functional blocks shown in the drawings and described below are only examples of possible implementations. In other implementations, different functional blocks may be used without departing from the spirit and scope of the detailed description. Moreover, although one or more functional blocks of the present invention are shown as individual blocks, one or more of the functional blocks of the present invention may be a combination of various hardware and software components that perform the same function.

Furthermore, the term “comprising” certain components, which is an “open-ended” term, simply refers to the presence of the corresponding components, and should not be understood as excluding the presence of additional components.

In addition, if a specific component is referred to as being “connected” or “coupled” to another component, it should be understood that it may be directly connected or coupled to another other component, but there may be other components therebetween.

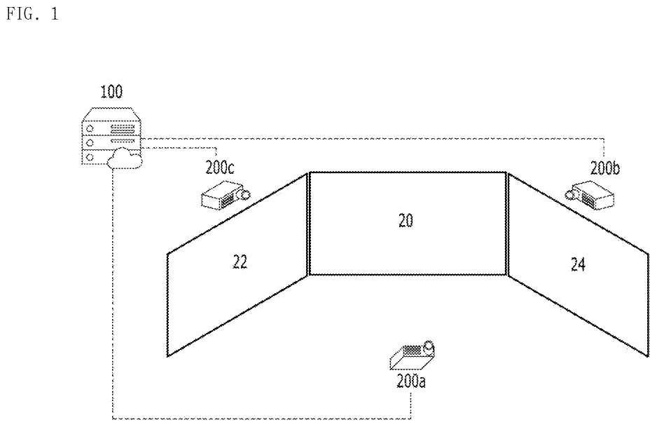

FIG. 1 is a schematic diagram illustrating the entire system required to implement a method and system for supporting the clustering of projection devices according to the present invention. Referring to FIG. 1, it is assumed that the system according to the present invention is provided in a theater equipped with at least one projection surface, preferably multiple projection surfaces 20, 22 and 24 as shown in the drawing, and the system includes at least a management server 100 and multiple projection devices 200a, 200b and 200c.

Before providing a detailed description of each component, a Representative Embodiment of the Present Invention Will Be Described With reference to FIG. 1.

Generally, a single projection device is used to output a video on one projection surface. However, in a multi-screen theater, where multiple projection surfaces are present by default, projection devices corresponding to the number of projection surfaces are installed. Furthermore, for various reasons, multiple projection devices may be assigned to each projection surface to project videos onto the respective surfaces. For example, if it is intended to project videos onto the side walls of the theater in addition to the front screen, a single projection device cannot cover the entire area of the side walls. Therefore, multiple projection devices are installed to achieve full coverage. In such a multi-screen theater where multiple projection devices are needed, it is much more efficient to define and control the multiple projection devices as a single cluster rather than controlling each projection device individually. Therefore, the present invention is intended to provide various interfaces that can support a user, i.e., an administrator, in the process of clustering multiple projection devices into a single cluster.

Referring again to FIG. 1, the system for supporting the clustering of projection devices according to the present invention may include a management server 100 and multiple projection devices 200 as the main components, which will be described in detail below.

The management server 100 is a computing device that can be operated by a person in charge of managing or operating the theater. It is connected to the main electronic devices in the theater via a network, allowing for control over each electronic device. The management server 100 according to the present invention can preferably be connected to the projection devices 200 via a network, allowing for remote control of the

Projection devices 200 when control commands are input via the management server 100. Moreover, the management server 100 can provide the theater administrator, i.e., the user, with the interfaces necessary for clustering the multiple projection devices. In this case, the management server 100 can provide these interfaces to the user either via an output device such as a monitor directly connected to the management server 100, or through a portable terminal such as a smart phone connected to the management server 100 via a network. Furthermore, in some cases, the management server 100 may have the function and authority to output movie content onto the projection surfaces within a theater, and in this case, the user can execute the automatic projection area adjustment function in advance each time the movie content is screened, ensuring that the audience enjoys high-quality visuals every time the video is screened.

For reference, it is assumed that the management server 100 includes a central processing unit and a memory. In this case, the central processing unit can also be referred to as a controller, microcontroller, microprocessor, microcomputer, etc. Moreover, the central processing unit can be implemented in hardware, firmware, software, or a combination thereof. When it is implemented using hardware, it can take the form of an application specific integrated circuit (ASIC), a digital signal processor (DSP), a digital signal processing device (DSPD), a programmable logic device (PLD), or a field programmable gate array (FPGA), and when it is implemented using firmware or software, the firmware or software can be configured to include modules, procedures, or functions that perform the above-mentioned functions or operations. Furthermore, the memory can be implemented using a memory such as a Read Only Memory (ROM), Random Access Memory (RAM), Erasable Programmable Read-Only Memory (EPROM), Electrically Erasable Programmable Read-Only Memory (EEPROM), flash memory, Static RAM (SRAM), Hard Disk Drive (HDD), or Solid State Drive (SSD). There is no limitation on the type of hardware required to implement the management server 100. For example, server computers, portable terminals (laptop computers, smartphones, etc.), desktop computers, etc. are representative examples of computing devices. In addition, in some cases, the management server 100 may be available in the form of a cloud server.

Next, the projection device 200 refers to a device for projecting videos, also known as a projector. Multiple projection devices 200 can be installed in a theater, with each projection device positioned to project video onto opposing projection surfaces. The types of projection devices 200 include, but are not necessarily limited to, those implemented with CRT, LCD, and DLP technologies. In the case of multiple projection devices 200, at least some of the projection devices may be available from different manufacturers based on different principles, and each of the projection devices 200 can be independently connected to the management server 100 via a network. In addition, in the projection device 200, parameters related to content output can be adjusted. For example, adjustments can be made to brightness (light source intensity of the projection device), contrast (difference between light and dark), color temperature, focus, zoom, or keystone correction. These parameters can also be adjusted through control commands input via the management server 100.

As described above, the system required for supporting the clustering of projection devices according to the present invention and its associated devices have been discussed with reference to FIG. 1.

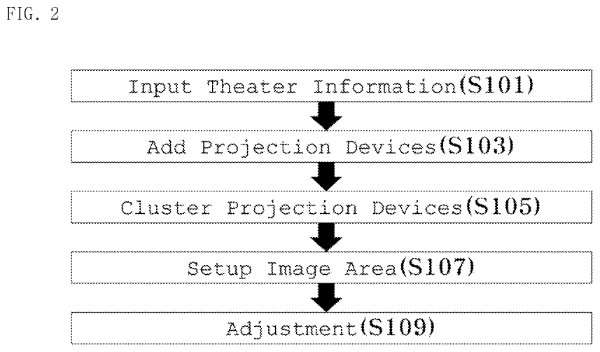

FIG. 2 is a flowchart illustrating a method for supporting the clustering of projection devices according to the present invention, and each step will be described in detail below.

Referring to FIG. 2, the method for supporting the clustering of projection devices may first include a step (S101) where the management server 100 receives theater information input from a user. This step may be the first step performed after the user runs the software for clustering the projection devices, as accurate input of basic information about the theater that the user wishes to manage is necessary for subsequent settings for the projection devices. On the other hand, if the theater information has already been input and stored after the user initially executed the software, this step may be omitted.

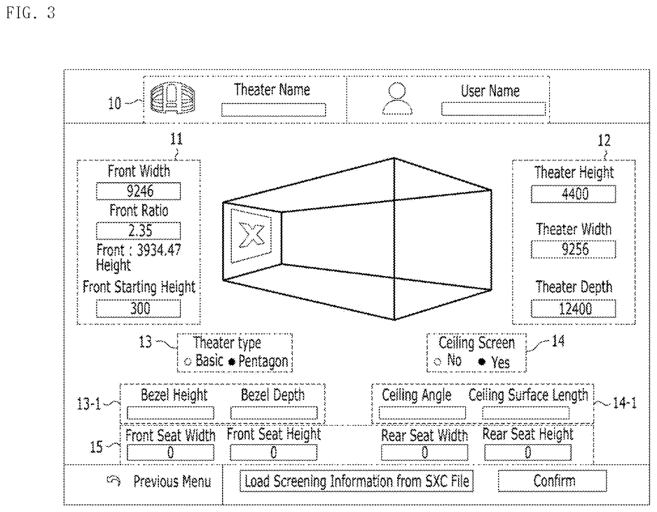

FIG. 3 illustrates an example of an interface provided to a user for inputting theater information, i.e., a theater information input interface.

Referring to FIG. 3, the theater information input interface may include an area 10 for inputting the theater name, and it may further include an area for inputting the current user's name. The theater information input interface may further include areas for inputting values related to the structure of the theater, including internal measurements of the theater building and/or measurements of the projection surfaces installed within the theater. The drawing shows an area 11 for inputting the width, ratio, and height starting from the floor of the main projection surface, and an area 12 for inputting the height, width, and depth of the theater. In addition, the theater information input interface may further display a three-dimensional diagram of the theater, where guidance text can be shown on this diagram to help the user easily recognize which part of the theater the specific value corresponds to when inputting values.

In addition, the theater information input interface according to the present invention may include an area 13 for inputting the theater type. In this detailed description, an angular C-shaped multi-screen theater, utilizing the front and the left/right side walls as the projection surfaces, is considered as the basic premise. However, additional projection surfaces may be present to connect the front and the left/right side walls as needed. If the presence of these additional projection surfaces alters the type of multi-screen theater, the area corresponding to reference numeral 13 in the drawing allows for selecting such options. Meanwhile, depending on the selection of the theater type, a bezel information input area 13-1 may be activated to allow for the additional input of bezel information. For example, when the theater type is selected as a pentagon (with five projection surfaces created by the front, left/right side walls, and additional projection surfaces connecting the front and side walls), if the height and length of the bezel area (the region between the front and side walls) are input, then the position where the image is distorted during projection can be displayed according to the input height and length values.

Moreover, the theater information input interface according to the present invention may further include an area 14 for inputting the presence or absence of a ceiling projection surface, and in this case, if it is selected that the ceiling projection surface is present, an area 14-1 may be activated to allow for the further input of the angle of the ceiling and the length of the ceiling projection surface.

Meanwhile, the theater information input interface according to the present invention may further include an area for inputting values related to the structure of the seats installed in the theater. The drawing shows an area 15 for inputting the front width and height of the seats, as well as the back width and height of the seats. furthermore, in regard to the seating structure within the theater, values such as the slope of a line obtained by connecting the highest points of the seats (the top of the backrest) when viewed from the side of the theater (the angle relative to the ground), the length of the seats, etc. can be further input.

Referring again to FIG. 2, after the input of theater information is completed, a step (S103) for adding projection devices for the actual clustering can be executed. In this step, the user can add the projection devices to be clustered by either directly inputting the projection devices to be clustered or selecting them from a list. In this step, a projection device setup interface may be provided to the user. This interface may include an input area where the user can directly input identification information for specific projection devices, or an input area where the user can select from a list. Moreover, if necessary, an input for the IP address matching the projection device may be required for adding the projection device, and an area for this input can also be included.

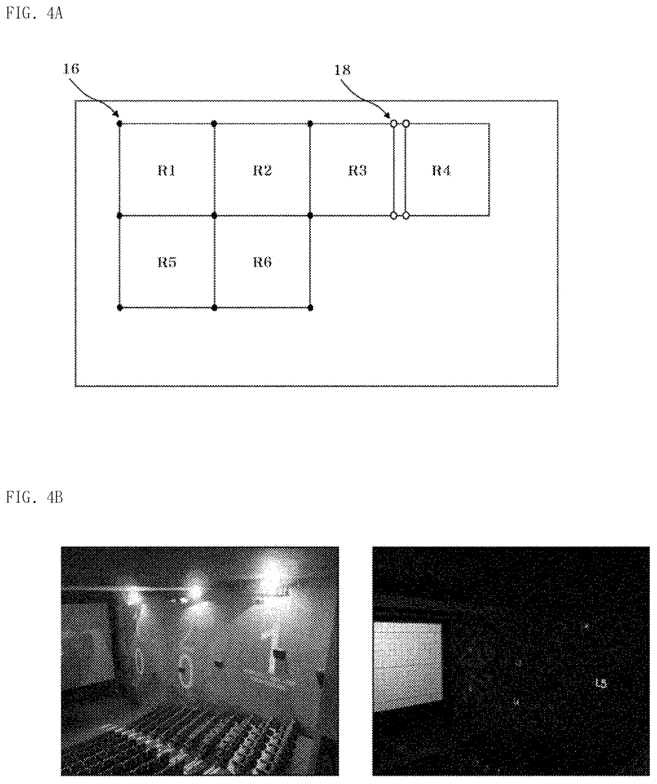

Meanwhile, in the step of adding projection devices, identifiers may be displayed on any projection surface to help the administrator easily identify which projection device is currently being added. FIG. 4a illustrates a theater projection surface 24 on which image areas output by multiple projection devices are displayed during the step of adding projection devices, and FIG. 4b shows photographs with identifiers displayed on any projection surface in an actual theater to identify the projection devices added. Referring to FIGS. 4a and 4b, the management server 100 according to the present invention allows the user to visually confirm which projection device is outputting which image area on the corresponding projection surface during the process of adding projection devices to be clustered. This enables the user to easily perceive the task of clustering multiple projection devices. In addition, the projection surface may include not only an identifier (letters or numbers) assigned to a specific projection device, but also hardware information of that projection device, allowing the user to more easily distinguish between the projection devices. In particular, if there is a projection device with hardware performance that differs from other projection devices, the user can position that specific projection device for use in a special purpose or designated area. In this case, if the hardware information of the projection device is displayed on the projection surface along with a simple identifier, the user can easily specify the image area associated with that the projection device.

Referring again to FIG. 2, after the step of adding projection devices, a step (S105) for clustering the corresponding projection devices may be executed. In this step, a clustering interface may be provided to the user, allowing the user to input a clustering adjustment input through the interface.

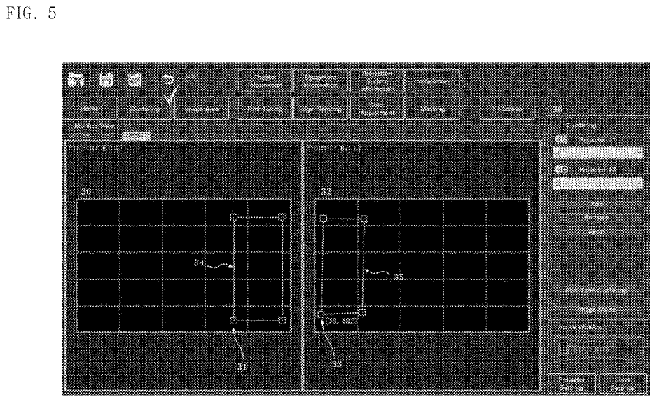

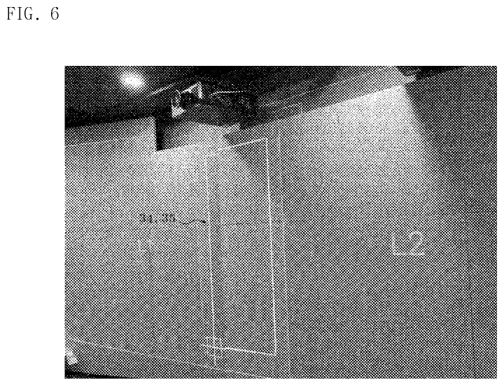

FIG. 5 illustrates an example of a clustering interface, which may include multiple projection screen areas 30 and 32 each corresponding to each of the multiple projection devices to be clustered, multiple clustering points 31 displayed on each projection screen area, and editing menus 36 for supporting the user's clustering adjustment input. The projection screen areas 30 and 32 are used to display virtual screen areas for each of the projection devices to be clustered, and it can be seen from the drawing that the projection screen areas 30 and 32 for projector #1 and projector #2 are present separately. Moreover, multiple clustering points 31 can be displayed within each projection screen area, and these clustering points 31 serve as a means for the user to arbitrarily adjust polygonal areas 34 and 35 formed by connecting the clustering points 31. In other words, the user can select a specific one of the clustering points 31 and move it freely to adjust the polygonal area. Among the clustering points 31, the one selected by the user and made movable will be referred to as a control point 33. Meanwhile, during the clustering step, an interface like that shown in FIG. 6 may be displayed on the actual projection surface. In other words, to support the user's clustering adjustment input, the polygonal area presented in FIG. 5 can be rendered on the actual projection surface as shown in FIG. 6. The point labeled 33 displayed on the projection surface in FIG. 6 corresponds to the control point 33 of FIG. 5, while the polygonal areas 34 and 35 displayed on the projection surface correspond to the polygonal areas 34 and 35 displayed on the projection screen areas of FIG. 5. In a state where such projection surface output is occurring, the user can adjust the clustering points 31 to ensure that the polygonal areas 34 and 35 are accurately overlapped while viewing the projection surface directly. In this detailed description, moving the clustering points 31 to align the projection areas of the respective projection devices will be defined as one of the clustering adjustment inputs.

Meanwhile, on the right side of the clustering interface shown in FIG. 5, there is an editing menu for supporting the user's clustering adjustment input. This editing menu may include an input area for selecting a projection device to be clustered, an input area for adding/removing/resetting the clustering points 31, an update request area for reflecting the adjustment inputs of the clustering points 31 on the actual projection surface, and an image display request area for projecting a specific image onto the projection surface.

In this way, it is preferable for the clustering interface to display at least three clustering points for each projection screen area, and to display a polygonal area by connecting these clustering points with a straight-line. The user can then adjust the clustering points to ensure that two polygonal areas displayed on the actual projection surface overlap each other, allowing the multiple projection devices to be clustered as a single cluster.

Referring again to FIG. 2, after the clustering step, an image area setting step (S107) may be executed. This step is intended to adjust the area so that a single image or video projected by the clustered projection devices can be output or projected onto a designated area. In this step, an image area setting interface may be provided to the user.

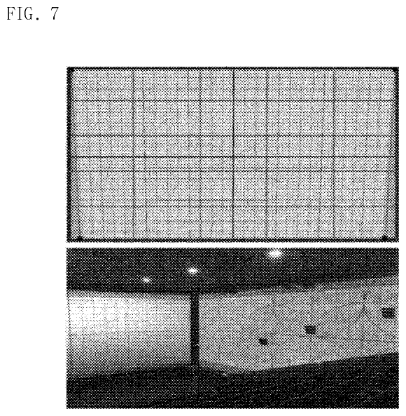

The image area setting interface provided in this step can be displayed on both the terminal used by the user and the actual projection surface within the theater. On the user's terminal, the basic menus for starting the image area setting and saving the settings are displayed, while on the actual projection surface, a reference area as shown in FIG. 7 can be displayed. That is, during the image area setting step, the user can adjust the size of the reference area displayed on the actual projection surface so that it covers the maximum area of the projection surface. For reference, at this time, the reference area may be pre-adjusted to match the aspect ratio according to the content ratio, and the user can proceed with the image area setting by adjusting the size of the reference area while maintaining the ratio. In contrast, the reference area may freely change its length according to the user's length change input without adhering to a specific ratio. For reference, the top of FIG. 7 shows the setup of the image area projected on the main projection surface, i.e., the front of the theater, while the bottom of FIG. 7 shows the setup of the image area projected on the right wall. For the image area projected onto the main projection surface, it is preferable for the reference area to be set to cover the maximum displayable area of the corresponding projection surface. In the case of the image area projected onto the side wall, it is preferable for the lengths of the image area in the vertical and horizontal directions to be adjusted to align with the height of the top of the main projection surface.

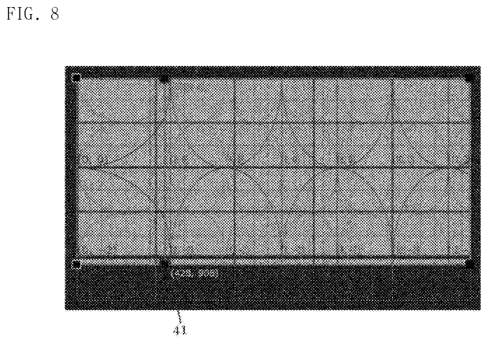

Meanwhile, as briefly mentioned earlier, when the theater type is pentagonal, the image area setting interface, as shown in FIG. 8, may be displayed on the user's terminal screen and/or the projection surface during the image area setting step in such a theater. In the case of a pentagonal theater, it was described that there is an additional projection surface that connects the main projection surface at the front and the projection surface, which can be defined as the bezel area. In this step, as shown in FIG. 8, while the reference area is displayed, control points 41 (different from the control point 33 described with reference to FIG. 5) are displayed, allowing the user to set the image area to align with the bezel area.

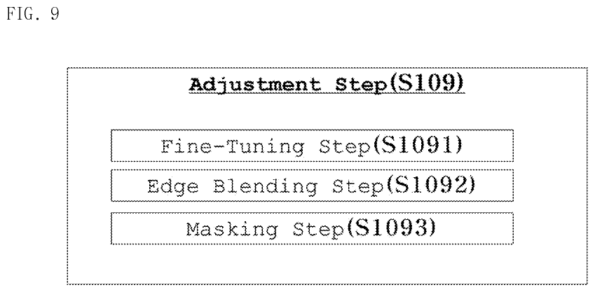

Referring again to FIG. 2, the method for supporting the clustering of projection devices according to the present invention may include an adjustment step (S109) performed on the projected image. As illustrated in FIG. 9, three types of adjustments can be performed during this adjustment step after the image area has been set, including fine-tuning that distorts at least some areas of the projected image; edge blending that adjusts the color, brightness, etc. of the overlapping boundary areas of the overlapping images; and masking that specifies masking areas to prevent the image from being projected onto certain parts of the projection surface.

First, in the fine-tuning step (S1091), an image warping interface is provided to allow the user to directly edit the warping of the image projected on the projection surface and to receive an image warping adjustment input from the user.

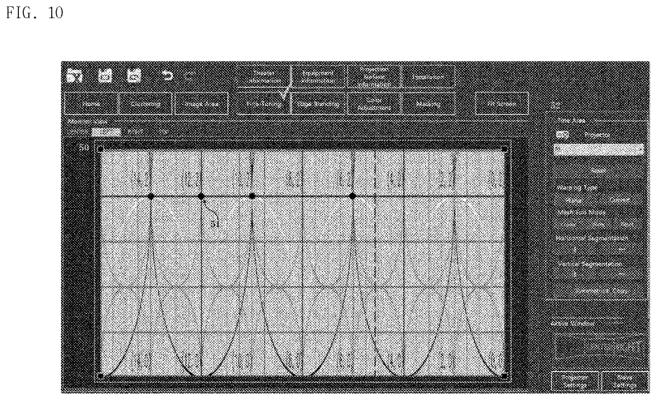

FIG. 10 illustrates an example of an image warping interface. Referring to FIG. 10, the image warping interface may include a mesh editing screen 50 for displaying at least multiple reference lines and multiple patterns, multiple control points 51 (different from the previously described control points) displayed on the mesh editing screen, and an editing menu 52 for supporting the user's image warping adjustment input.

The user can adjust the control points 51 on the mesh editing screen 50 to induce distortion in the image projected onto the projection surface. In doing so, the user can easily make adjustment inputs by utilizing the various functions in the editing menu 52. The editing menu 52 may include an area for selecting the warping type, an area for selecting the mesh editing mode, an area for adding subdivided reference lines in the horizontal or vertical direction, etc. The warping types may include a planar type and a curved type. The planar type is intended to achieve the effect of image warping editing on a plane through mesh manipulation, while the curved type is intended to achieve the effect of image warping editing on a curved (nonlinear) surface. In addition, the mesh editing mode may include a creation mode that allows the user to adjust the positions by directly manipulating the control points 51, and a warping mode that allow the user to perform image warping based on the adjusted control points 51. The editing menu 52 may further include a symmetry copy menu which is intended to reduce the user's effort by allowing the user to create a symmetrical copy of the edited image warping on one side to the opposite side, considering that in many cases, the left and right structures of a screening room are designed and built symmetrically. If the image warping editing on one side has been completed, the same editing result can be symmetrically applied to the other side.

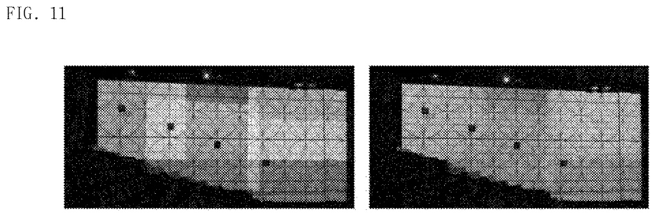

The edge blending step (S1092) is intended to correct overlapping areas, especially among the images projected by the multiple clustered projection devices, ensuring that these areas appear natural as if they were projected by a single projection device. In this step, an edge blending interface may also be provided to the user. The edge blending interface displayed on the user's terminal may include an area for requesting the start of edge blending, and an area for selecting a projection surface or image area to be edge-blended. The user can simply select the projection surface or image area that requires edge blending, which will automatically initiate the edge blending, and as a result, the user can verify the projection appearance as shown in FIG. 11.

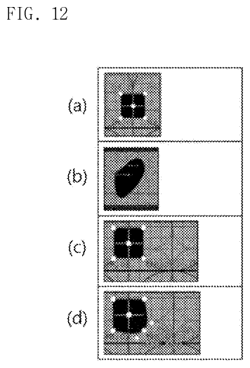

The masking step (S1093) is intended to allow the user to specify the area to be masked, such as an area occupied by seats, an area where a device such as a speaker is installed, or any other areas where the video projection is unnecessary. In this masking step, a masking interface may also be provided to the user, through which various types of masking functions can be presented, as illustrated in FIG. 12. Referring to FIG. 12, (a) illustrates the straight-line masking function, while (b) illustrates the curved masking function. The straight-line masking function is intended to display a polygon composed of line segments, such as a rectangle, on the image area to mask the corresponding area. The curved masking function is intended to display a closed surface defined by any closed curve on the image area, allowing the user to adjust the area of the closed surface by a drag input to mask the corresponding area. The masking interface may further provide a straight-line adjustment function as shown in (c), and a curved adjustment function as shown in (d). The straight-line adjustment function is intended to allow the user to adjust the specified masking area in straight-line directions (vertical, horizontal, diagonal, etc.), and the curved adjustment function is intended to allow the user to freely adjust the specified masking area.

As described above, the method and system for supporting the clustering of projection devices have been discussed. Meanwhile, the present invention is not limited to the specific embodiments and applications described above, and various modifications can be made by those skilled in the art without departing from the gist of the present invention as claimed in the claims. These modified implementations should not be understood as being separate from the technical spirit or scope of the present invention.

1. A method for supporting the clustering of projection devices, comprising:
(a) a theater information setup step of providing a theater information input interface that allows a user to set up theater information and receiving a theater information input for a theater that includes multiple projection surfaces from the user;
(b) a projection device addition step of providing a projection device setup interface for setting up multiple projection devices to output images across the multiple projection surfaces and receiving a projection device addition input for the multiple projection devices from the user; and
(c) a clustering step of providing a clustering interface for clustering the added multiple projection devices and receiving a clustering adjustment input from the user.

2. The method for supporting the clustering of projection devices according to claim 1, further comprising:
(d) an image area setting step of providing an image area setting interface for setting up an image area of the images projected by the clustered projection devices and receiving an image area adjustment input from the user.

3. The method for supporting the clustering of projection devices according to claim 1, wherein the clustering interface comprises:
multiple projection screen areas each corresponding to each of the projection devices to be clustered;
multiple clustering points displayed on each of the projection screen areas; and
an editing menu for supporting the user's clustering adjustment input.

4. The method for supporting the clustering of projection devices according to claim 3, wherein clustering projection points each corresponding to each of the multiple clustering points are displayed on a projection area where the images output by the multiple projection devices are projected, and
wherein the clustering adjustment input from the user comprises an input that the user wishes to overlap at least some of the clustering projection points.

5. The method for supporting the clustering of projection devices according to claim 4, wherein the clustering interface further displays a polygon formed by connecting the multiple clustering points, and a polygon formed by connecting the clustering projection points on the projection area.

6. The method for supporting the clustering of projection devices according to claim 2, further comprising, after step (d), a fine-tuning step of providing an image warping interface for editing the warping of the images projected by the clustered projection devices and receiving an image warping adjustment input for fine-tuning the images from the user.

7. The method for supporting the clustering of projection devices according to claim 6, wherein the image warping interface comprises:
a mesh editing screen for displaying multiple reference lines and multiple patterns;
multiple control points displayed on the mesh editing screen; and
an editing menu for supporting the user's image warping adjustment input.

8. The method for supporting the clustering of projection devices according to claim 2, further comprising, after step (d), an edge blending step of providing an edge blending interface for edge blending of the images projected by the clustered projection devices and receiving an image area to be edge-blended and an edge blending start input from the user.

9. The method for supporting the clustering of projection devices according to claim 2, further comprising, after step (d), a masking step of providing a masking interface for masking at least some areas of the images projected by the clustered projection devices and receiving a masking area editing input from the user.

10. The method for supporting the clustering of projection devices according to claim 9, wherein the masking interface comprises editing menus for supporting the user's masking area editing input, wherein the editing menus comprises:
a masking area display button; and
a button for linear editing or curved editing of the masking area.

11. A management server for supporting the clustering of projection devices, the management server comprising a central processing unit and a memory, wherein the central processing unit executes instructions stored in the memory for performing a method for supporting the clustering of projection devices,
wherein the method for supporting the clustering of projection devices comprises:
(a) a theater information setup step of providing a theater information input interface that allows a user to set up theater information and receiving a theater information input for a theater that includes multiple projection surfaces from the user;
(b) a projection device addition step of providing a projection device setup interface for setting up multiple projection devices to output images across the multiple projection surfaces and receiving a projection device addition input for the multiple projection devices from the user; and
(c) a clustering step of providing a clustering interface for clustering the added multiple projection devices and receiving a clustering adjustment input from the user.

12. The management server according to claim 11, wherein the method for supporting the clustering of projection devices further comprises:
(d) an image area setting step of providing an image area setting interface for setting up an image area of the images projected by the clustered projection devices and receiving an image area adjustment input from the user.
